(19) United States
(12) Patent Application Publication
(10) Pub. No.: US 2003/0133293 A1
(43) Pub. Date: Jul. 17, 2003

(54) Rapid shaping strips with strings of christmas lights

(76) Inventor: Mei-Lu Lin, Feng-Yuan City (TW)

Correspondence Address: MEI-LU LIN, P.O. BOX 697, Feng-Yuan City 420, TW

(21) Appl. No.: 10/043,298

(22) Filed: Jan. 14, 2002

(51) Int. Cl. F21V 21/00

(52) U.S. Cl. 362/249

(57) ABSTRACT

A rapid shaping strips with strings of Christmas lights includes a pair of strips made of soft and foldable material and connected together at their tops and their lateral sides by a plurality of pairs of oblique sutures toward each other to define a plurality of spaces at different intervals, a pair of alignments of circular thru holes spacedly and parallel extended in each of the strips along the length thereof. Each of the circular thru holes has a protrudent collar on outer side for sequentially engaging the lamps of the strings of Christmas lights. A pair of superfluous electric wires are fixed at the top of the strips and extend downward through the center of the strips along the length thereof and connect to an external power source. Thereby, draw the electric wires downward and squeeze the strips upward, a shape of flower is promptly formed with the lamps to glitter thereon.

### BACKGROUND OF THE INVENTION

The present invention relates to the string of Christmas light and more particularly to the rapid shaping strips with strings of Christmas lights which the strips can be rapidly to make a shape of flower or other shape of patterns.

Typical strings of Christmas lights usually revolve around a pine tree or hang on something or attach to a plate to make shapes of a star, an animal, etc. However, the plate is too large to pack. Besides, each plate can only make a shape of pattern. If one wants to make different shapes, it must prepare a plenty of different plates that is not so economical.

### SUMMARY OF THE PRESENT INVENTION

The present invention has a main object to provide the rapid shaping strips with strings of Christmas lights in which the strips is foldable to be ready to pack and to be rapidly to make shapes of flower or other shapes of patterns.

Accordingly, the rapid shaping strips with strings of Christmas lights of the present invention comprises at least a pair of strips and strings of Christmas lights. The strips are spacedly sewed at their lateral edges a plurality of pairs of oblique sutures toward each other to make a plurality of spaces of different length of intervals for the strips and at least an alignment of circular thru holes centrally and spacedly extended along the length thereof for sequentially engaging with lamps of the strings of Christmas lights. The electric wires connect each of the lamps and finally fix to the top of the strips and extend downward through the center of the strips. When draws the electric wires more downward and squeezes the strips upward. The strips are form into different sized three-dimensional shapes and look as a flower.

The present invention will become more fully understood by reference to the following detailed description thereof when read in conjunction with the attached drawings.

### BRIEF DESCRIPTION OF THE DRAWINGS

FIG. 1 is a plane view to show that the strips are sewed with a plurality of the oblique sutures at their lateral edges at different intervals,

FIG. 2 is a plane view to show that the strips squeezed upward to for form different sized three-dimensional shapes,

FIG. 3 is a perspective view to show that the strips are accomplished an expected shaped,

FIG. 4 is a plane view to show that the lamps are engaged into the circular thru holes of the strips,

FIG. 5 is a perspective view and partially sectional view the condition of the engagement of the lamps in the circular holes of the strips,

FIG. 6 is a plane view the lamps in the circular thru holes of the strips, and

FIG. 7 is a perspective view to show that the strips are shaped into a flower.

### DETAILED DESCRIPTION OF THE PREFERRED EMBODIMENT

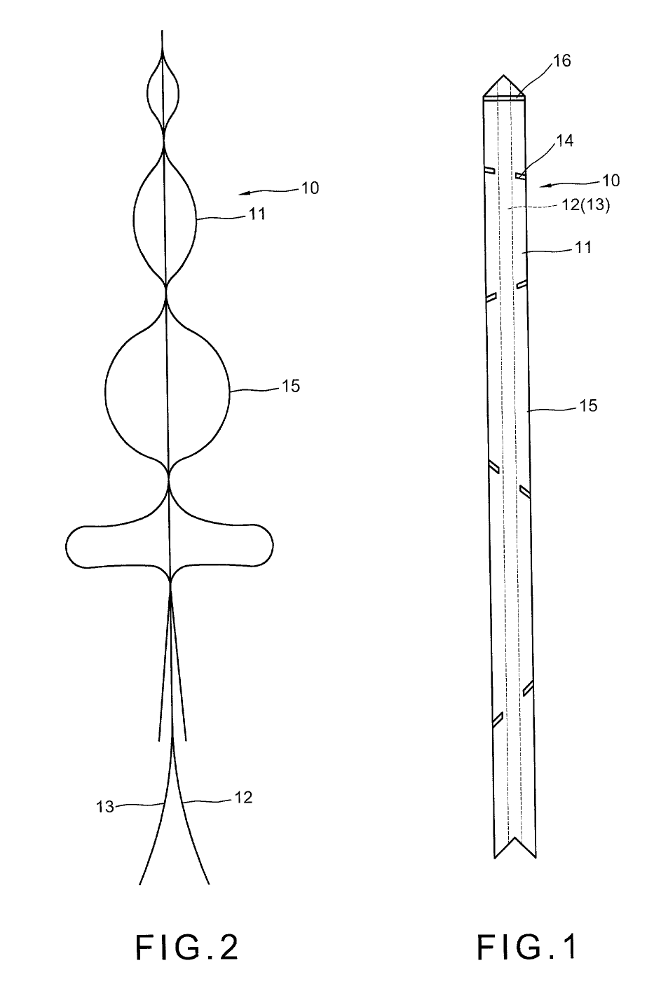

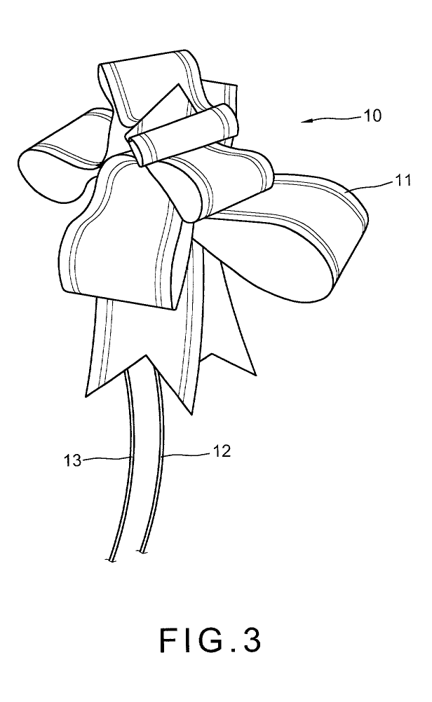

With reference to FIGS. 1, 2 and 3 of the drawings, the rapid shaping strips with strings of Christmas lights 10 of the present invention comprises at least a pair of strips 11 and strings of Christmas lights 20. The strip 11 is plane and made of soft, foldable materials such as the cloth or plastic. When a pair of strips 11 combine together, their tops are connected and their lateral edges are spacedly sewed with plurality of oblique sutures 14 at different intervals 15 and a pair of electric wires 12 and 13 are fixed at the top 16 of the strips 11 and extend through the center of the strips 11 along the length thereof. If draw the electric wires 12 and 13 downward and squeeze the strips 11 upward, the intervals 15 of the strips 11 are becoming arcuate looked like the petals of flower in different size and symmetrical to each other (as shown in FIGS. 2 and 3).

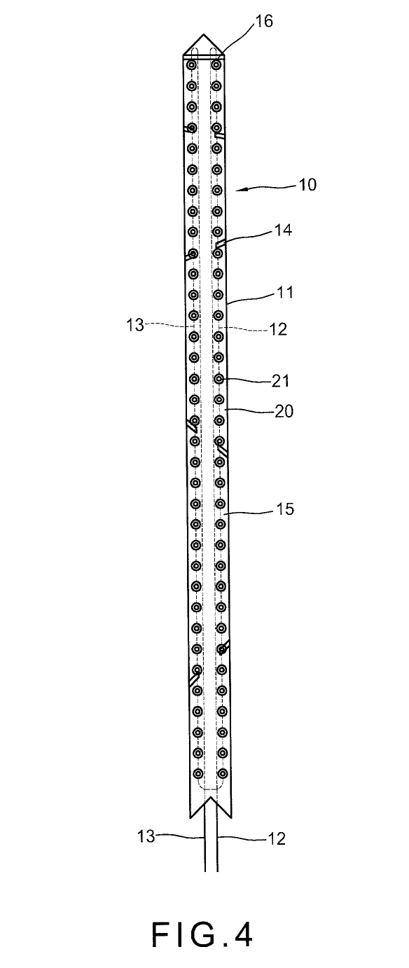

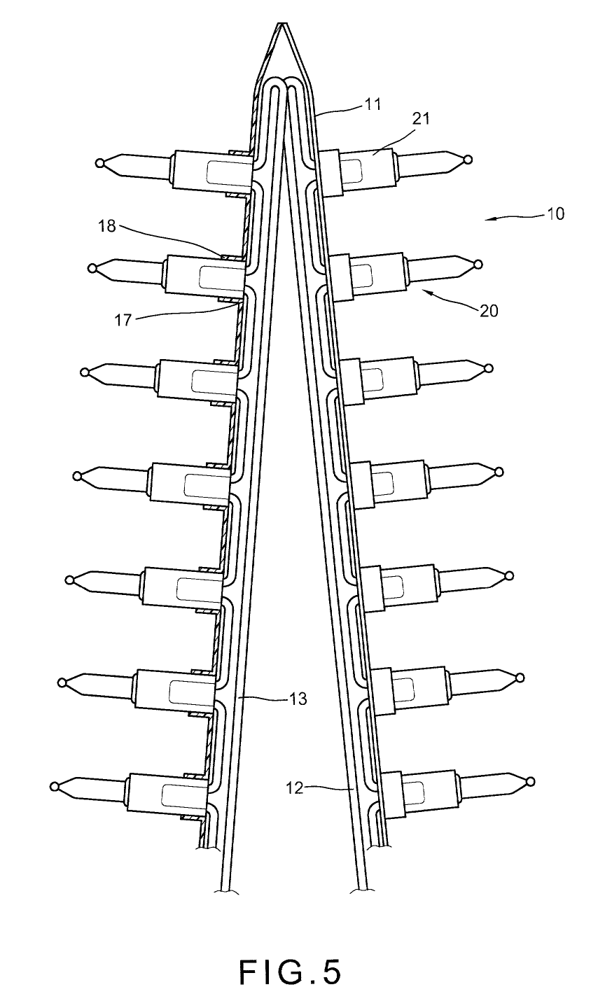

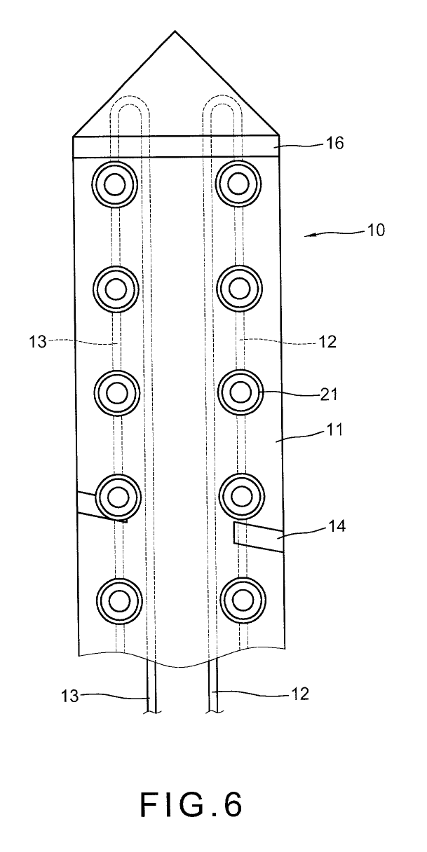

Referring to FIGS. 4, 5 and 6, the strip 11 each has two alignments of circular thru holes 17 spacedly and parallel extended along the length of the strip 11 and each of the circular thru holes 21 has a protrudent collar 18 projected outward for sequentially engaging the lamps 21 from the lower end to the upper end of the strip 11. The superfluity of the electric wires 12 and 13 are fixed to the top of the strips 11 and then extended downward through the center of the strips 11 and finally connected to an external power source (as shown in FIGS. 5 and 6).

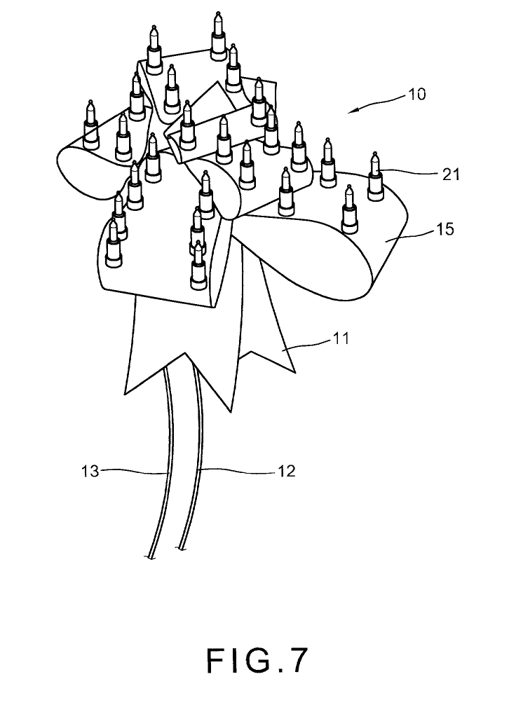

When draws the lower end of the electric wires 12 and 13 downward and squeezes the strips 11 together with the strings of Christmas light 20 upward, a shape of flower is therefore formed. The lamps 21 on the flower to present glitter (as shown in FIG. 7).

The rapid shaping strips with strings of Christmas lights of the present invention has the advantages of ready manufacture, rapid shaping and prompt restoring to original condition. It can be also adopting three pieces of strips or even four pieces of strips to form a rectangular shape which can be made a shape of flower of more three-dimensional effect.

Note that the specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A rapid shaping strips with strings of Christmas lights comprising:
at least a pair of strips connected together at their tops and their lateral edges where is sewed with a plurality of pair of oblique sutures toward each other to define different intervals, each of said strips having at least an alignment of circular thru holes spacedly and longitudinally extending along the length thereof and each of said circular thru holes having a protrudent collar projected outward;
at least a pair of strings of Christmas lights respectively combined with the strips on inner side each having a plurality of lamps connected by electric wires and sequentially engaged into the protrudent collars of the strips from lower end to upper end of the strips, a part of superfluous electric wires having been fixed at the top of the strips and extending downward through center of the strips along the length thereof and then connected to an external power source;
whereby, draw the superfluous wires downward and squeeze the strips upward, a shape of flower is rapidly presented with the lamps to glitter thereon.

2. The rapid shaping strip as recited in claim 1 wherein said strip is made of soft and foldable material such as the cloth and or the plastic.
